(19) United States
(12) Patent Application Publication
(10) Pub. No.: US 2020/0053108 A1
(43) Pub. Date: Feb. 13, 2020

(54) UTILIZING MACHINE INTELLIGENCE TO IDENTIFY ANOMALIES

(71) Applicant: APPLE INC., Cupertino, CA (US)

(72) Inventors: Gencer Cili, San Jose, CA (US); Sairam T. Gutta, Cupertino, CA (US); Eyal Gurgi, Petah-Tikva (IL); Moshe Neerman, Kiryat Ono (IL); Mor Doron, Shoham (IL); Franco Travostino, San Jose, CA (US); Naftali Sommer, Rishon LeZion (IL)

(21) Appl. No.: 16/057,732

(22) Filed: Aug. 7, 2018

(51) Int. Cl. H04L 29/06; G06F 11/07; G06K 9/62; G06N 99/00; G06F 17/30

(52) U.S. Cl. CPC H04L 63/1425; H04L 63/1441; G06F 11/079; G06F 17/30598; G06K 9/623; G06N 99/005; G06K 9/6276

(57) ABSTRACT

The subject technology receives an input data set including rows of values for features of the input data set, each row including a different combination of values for the features. The subject technology classifies one or more rows of values as an anomaly based on anomaly scores determined for each of the rows of values. The subject technology determines a subset of the different features that affect the anomaly scores of the one or more rows classified as the anomaly. The subject technology determines a root cause for at least one of the rows classified as the anomaly based on values of the subset of the different features for the at least one of the rows. The subject technology provides an indication of the root cause to a device to enable the device to perform an action when encountering conditions corresponding to the root cause at a subsequent time.

### TECHNICAL FIELD

The present description generally relates to anomaly detection for data stored in databases, including detecting anomalies in data related to applications executing on one or more devices.

### BACKGROUND

Existing techniques for anomaly detection of log files can require manual review by developers or system administrators, which can be difficult and inefficient. Other approaches for anomaly detection of log files may utilize rules provided by expert systems that can require frequent updating to adapt to changes in behavior from executing applications.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example network environment for providing anomaly detection in accordance with one or more implementations.

FIG. 2 illustrates an example computing environment for providing anomaly detection in accordance with one or more implementations.

FIGS. 3A-3D illustrates an example table including input data for anomaly detection in accordance with one or more implementations of the subject technology.

FIG. 4 conceptually illustrates an example visualization of applying a local outlier factor (LOF) technique to identify one or more anomalies in the input data corresponding to various feature combinations.

FIG. 5 illustrates an example of LOF related data included in the table in accordance with one or more implementations of the subject technology.

FIG. 6 conceptually illustrates an example use of mutual information for determining important features in accordance with at least one implementation of the subject technology.

FIG. 7 illustrates an example of tables with conditional mutual information in accordance with some implementations of the subject technology.

FIG. 8 illustrates an example chart representing a time series in accordance with some implementations of the subject technology.

FIG. 9 illustrates example plots of a distribution related to a particular KPI to determine relevancy or irrelevancy in accordance with one or more implementations of the subject technology.

FIG. 10 conceptually illustrates an example workflow for generating rules to provide to a device in order to facilitate addressing an anomaly in accordance with one or more implementations of the subject technology.

FIG. 11 conceptually illustrates an example rule in accordance with one or more implementations of the subject technology.

FIG. 12 illustrates a flow diagram of an example process for determining an anomaly in accordance with one or more implementations.

FIG. 13 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

For a given computing device, execution anomalies from applications executing on the computing device, including erroneous behavior or unexpected long response times, may cause losses of revenue and/or unsatisfactory user experiences. In an example, such anomalies may be caused by hardware problems, network communication congestion, and/or software bugs. Computing devices, in many cases, generate and store log messages related to events that occur from executing applications in log files for troubleshooting by developers and administrators. These log files also be stored in a database system for future querying, such as to extract information for analyzing the log files.

Computing devices may include software systems that may be used, in conjunction with hardware resources on such devices, to perform complex processes. An example of such a process may involve a computing device, with telephony capabilities, making a call to another device. Events that occur during such a process may be used to determine a set of performance measures in the form of Key Performance Indicators (KPIs). As used herein, a key performance indicator (KPI) is a quantifiable measure of a software application's performance. In one or more implementations, the subject technology may utilize KPIs to determine events that are related to failures of a process performed by the software application (e.g., voice call drop failure rate indicating a percentage of call failures).

Implementations of the subject technology described herein can also detect a root cause for software regressions (e.g., a software bug that makes a particular software feature stop functioning as intended after a certain event e.g., a system upgrade, system patching or a change to daylight saving time, etc.) in an automated and timely manner. Further, the subject technology minimizes the need to periodically manually monitor and analyze reports, and enables building a scalable solution that may eliminate manual data analysis, such as by intuition and/or ad-hoc measures.

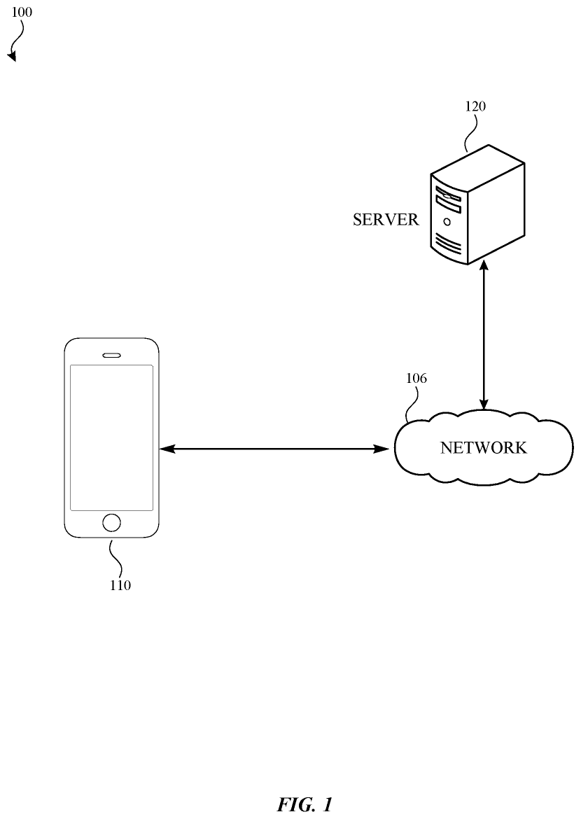

FIG. 1 illustrates an example network environment 100 for providing anomaly detection in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including an electronic device 110, and a server 120; however, the network environment 100 may include any number of electronic devices and any number of servers.

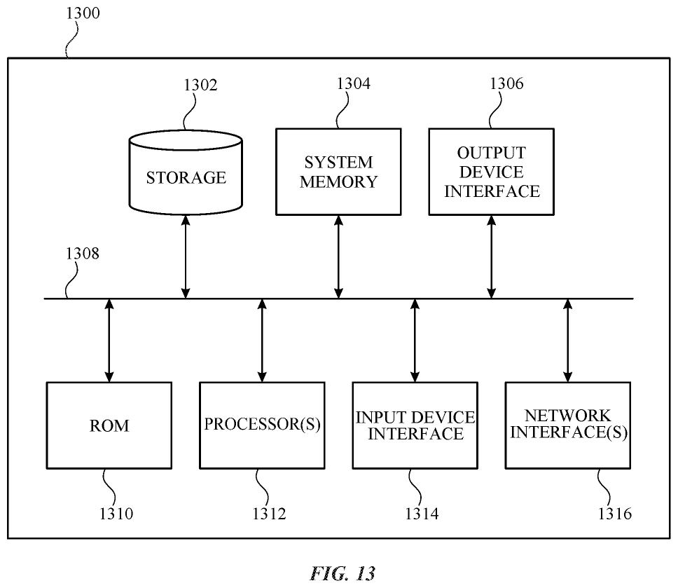

The electronic device 110 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a desktop computer. The electronic device 110 may be, and/or may include all or part of, the electronic system discussed below with respect to FIG. 13.

The electronic device 110 may include a framework that provides access to different software libraries. A framework can refer to a software environment that provides particular functionality as part of a larger software platform. In one or more implementations, the electronic devices 110 may include a framework that is able to access and/or execute telephony related functionality (e.g., setting up a call, etc.), which may be provided in a particular software library in one implementation.

The electronic device 110 may execute applications that populate one or more log files with log entries. For example, an application may execute code that prints out (e.g., writes) log entries into log files when performing operations in accordance with running the application, such as for debugging, monitoring, and/or troubleshooting purposes. The log entries may correspond to error messages and/or to unexpected application behavior that can be detected as anomalies using the subject technology. Examples of anomalies include errors in connection with work flow that occurs during execution of the application (e.g., call setup failure), while some other anomalies are connected to low performance where the execution time takes much longer than expected in normal cases although the execution path is correct.

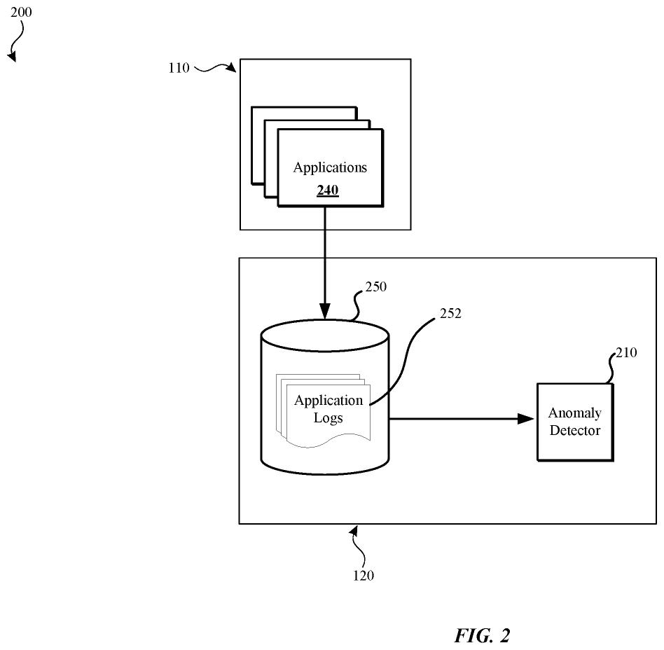

FIG. 2 illustrates an example computing environment 200 for providing anomaly detection in accordance with one or more implementations. In the example of FIG. 2 as described below, the computing environment 200 is provided by the server 120 of FIG. 1, such as by a processor and/or memory of the server 120; however, it is appreciated that, in some examples, the computing environment 200 may be implemented at least in part by any other electronic device. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the computing environment 200 includes a memory 250 including application logs 252. In an example, each of the application logs 252 may be stored as one or more log files with multiple log lines in the memory 250. Each log entry may correspond to a log line in a given log file. Applications 240 may be executing on the electronic device 110 and provide log entries that are stored within one or more of the application logs 252. Each of the applications 240 may include one or more threads (e.g., a single threaded or multiple threaded application) in which a thread may be performing operations for the application. A given application with multiple threads can therefore perform respective operations concurrently in respective threads.

As further shown, the computing environment 200 includes an anomaly detector 210 which is configured to perform anomaly detection using at least local outlier factor (LOF) techniques and conditional mutual information, and further identifying trends in data related to features to facilitate eliminating particular features that are irrelevant to an anomaly as further described herein. Although LOF techniques are discussed in the examples herein, it is appreciated that other techniques for determining anomalies may be utilized by the subject technology. The anomaly detector 210 may also perform pre-processing operations on data stored in the application logs 252, such as data filtering and/or aggregation of data based on different criteria as discussed further herein. Additionally, the anomaly detector 210 may automatically generate rules to address an anomaly, which are then pushed to a device to potentially handle or avoid an anomaly at a future time.

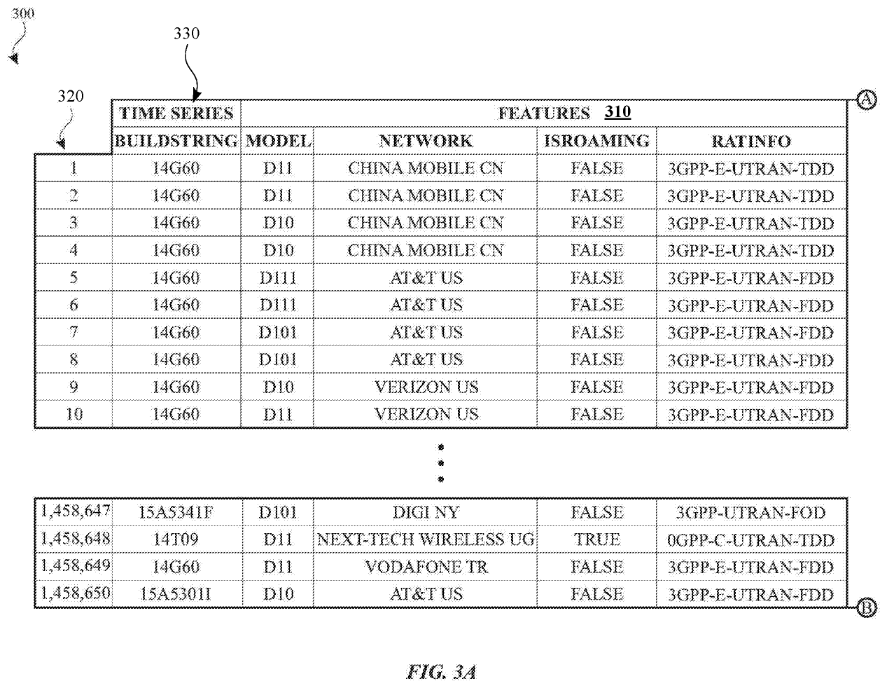

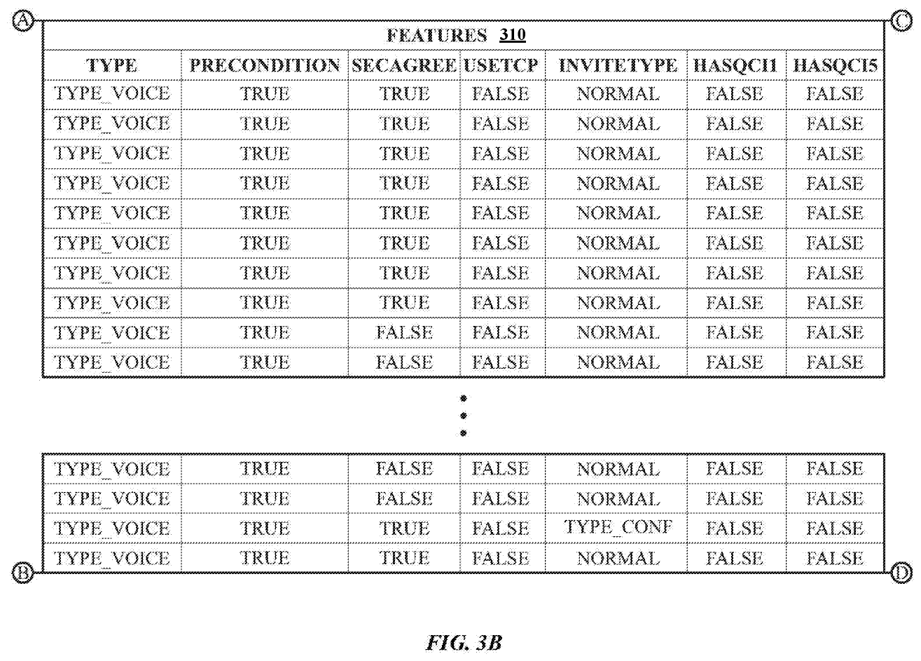

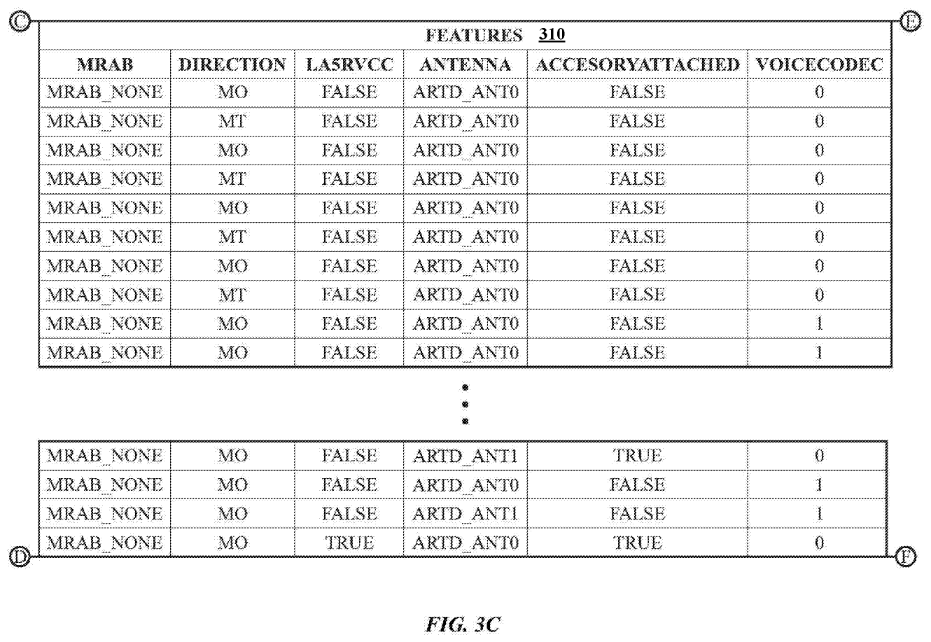

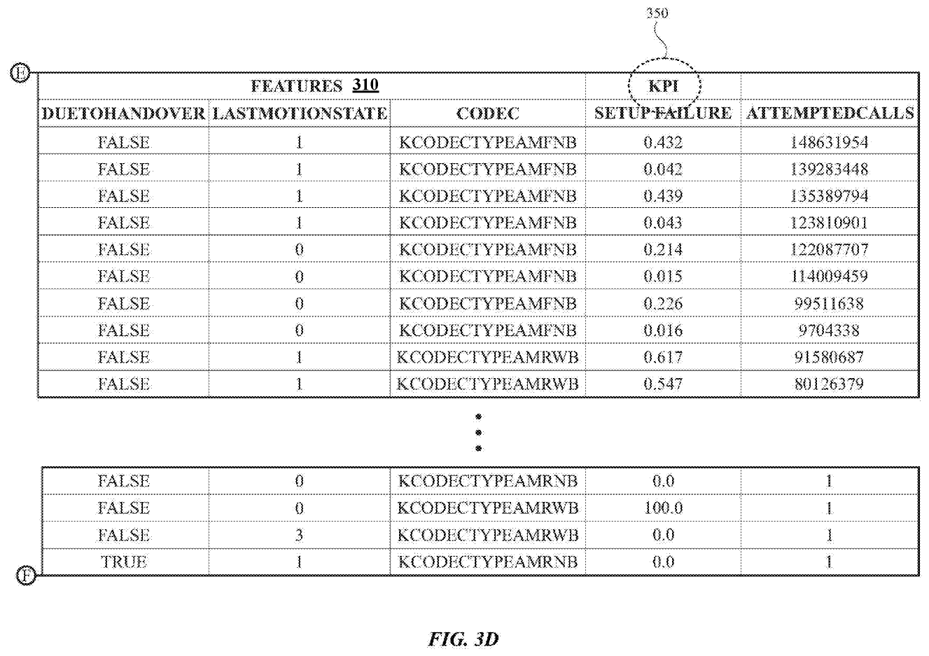

FIGS. 3A-3D illustrates an example table 300 including input data for anomaly detection in accordance with one or more implementations of the subject technology. The table 300, in one or more implementations, may be stored in a relational database and/or any other appropriate database using a storage scheme for storing such data in a database table format.

Depending on number of values for features 310 in the table 300, a total number of rows 320 can be significant. As illustrated, the table 300, for explanatory purposes, illustrates details pertaining to VoLTE (Voice over Long-Term Evolution) call functionality. However, log data from any other functionality may also be collected and utilized in a similar manner to detect anomalies.

The table 300, as shown in FIGS. 3A-3D, includes twenty (20) features and conceptually illustrates a number of data points (group or combination of feature values) of one-million, four-hundred fifty-eight thousand, six-hundred and fifty (1,458,650). As shown, each of the features 310 in the table 300 is in a respective column. Further, in FIG. 3D, a column related to a voice call drop failure rate is considered a KPI 350 that is determined, in an implementation, based on a particular combination of feature values (e.g., the data point). A data point as referred to herein may be understood as a particular combination of feature values (e.g., respective values of the twenty features in a particular row of the table 300). Thus, in the table 300, the feature values of each row corresponds to a respective data point. Moreover, each data point, including the respective feature values, may have been extracted from log data (e.g., application logs 252). As used herein with respect to discussion of the data set (e.g., from a given table of data) that undergoes various processing by the anomaly detector 210, the term “feature” may called a “dimension” or vice versa for referring to a particular column of data from a table (e.g., the table 300).

In the table 300, a time series dimension 330 could correspond to an actual time and/or actual date; however it is appreciated that the time series dimension as utilized by the subject technology may be a changeable dimension outside of time (e.g., a software version). Each feature in a respective column of the table 300 may be considered a different dimension that can grouped according to the time series dimension. As mentioned already, the KPI 350 relates to the voice call drop failure rate (e.g., percentage of time where the call has failed). In one or more implementations, the anomaly detector 210 groups entire datasets by the time series dimension with the different feature values, and then determines the KPI. Each of the features in respective columns of the table 300 can have an effect on the KPI 350.

In one or more implementations, the anomaly detector 210 removes statistically insignificant feature value(s) and/or feature combinations from the table 300, e.g., feature values and/or feature combinations that do not significantly impact the KPI 350. As referred to herein, a feature combination includes a combination of respective values corresponding to respective features (e.g., as shown in a particular row of the features 310 in the table 300). In an example, the anomaly detector 210 may utilize statistical filtering on the input data to remove decoys, e.g., features values that do not impact the KPI 350, and focus on the features values that impact the KPI 350. Such statistical filtering may be based on at least one threshold (e.g., a cutoff threshold), although more than one threshold may be utilized in some implementations (e.g., two separate thresholds corresponding to a lower bound threshold and an upper bound threshold). In an example, the anomaly detector 210 may plot the data as a probability density function (PDF) and determine a cutoff from the PDF to remove features and/or feature combinations without a sufficient sample size such as having a very low occurrence in the input data set (e.g., the application logs 252). In an example, the threshold may be configured such that 90% of the dataset, after filtering, remains in the input data. The filtered input data may then be applied through a local outlier factor algorithm as discussed further below.

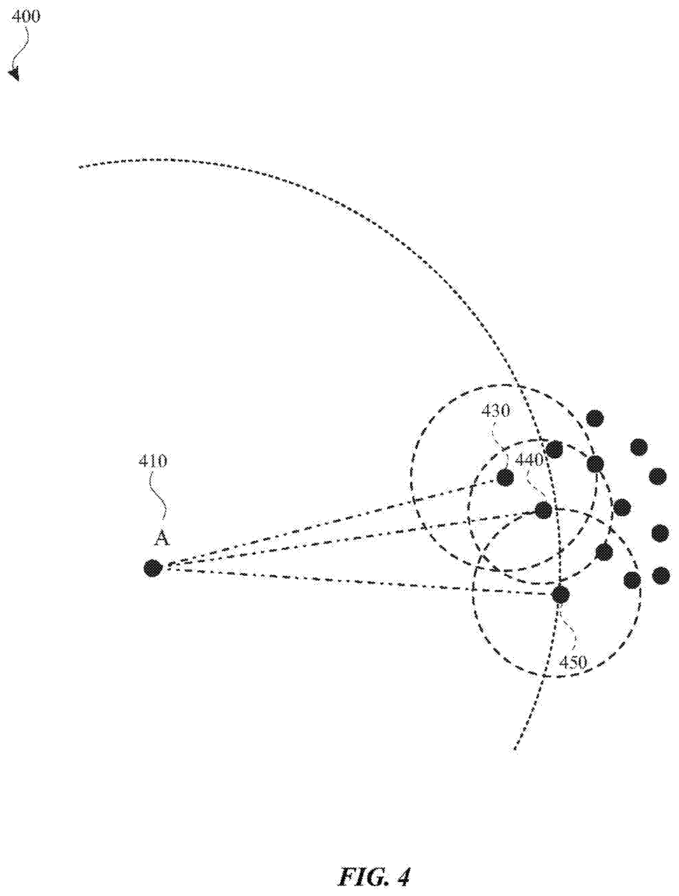

FIG. 4 conceptually illustrates an example visualization 400 of applying a local outlier factor (LOF) technique to identify one or more anomalies in the input data (e.g., the application logs 252) corresponding to various feature combinations. The visualization 400, for example, depicts a comparison of a given data point in a vector space to neighbor points for determining respective densities of each point and identify whether the given data point is considered an anomaly. In the visualization 400, each remaining feature combination (e.g., after filtering based on the thresholds) is a different data point.

In one or more implementations, the anomaly detector 210 utilizes the LOF technique to detect anomalies, based on feature combinations, in the input data (e.g., after filtering based on thresholds as discussed above). As an example, the LOF technique determines anomalous data points by measuring the local deviation of a given data point with respect to its neighbors. The anomaly detector 210 utilizes the LOF technique for assigning an anomaly score to each data point by computing the ratio of the average densities of the data point's neighbors to the density of the data point itself as follows:

$$\hat{f ( p )} = \frac{k}{{\sum }_{x ∈ N ( p )} d ( p , x )}$$

$$LOF ( p ) = \frac{\frac{1}{k} {\sum }_{x ∈ N ( p )} \hat{f ( x )}}{\hat{f ( p )}}$$

where k indicates the number of neighbors, N(p) is the set of k nearest neighbors and d(p, x) is the distance between two data points p and x.

In the example of FIG. 4, a data point 410 (e.g., corresponding to point A) has a much lower density than its neighbors corresponding to data points 430, 440, and 450. As a result, the data point 410 may be scored with higher anomaly score than the data points 430, 440, and 450. The anomaly detector 210, using a configurable threshold value, may then classify each data point as either an anomaly or not an anomaly based on the threshold value. For example, a given anomaly score may be classified as an anomaly if the score is greater than the threshold value, or vice-versa.

In an example, one advantage of the LOF technique is that it produces an outlier prediction value (e.g., an anomaly score) and not a binary decision indicating whether a data point is an anomaly or not. Based on the anomaly score (e.g., the outlier prediction value), an anomaly class is generated to classify the corresponding data point as an anomaly or not an anomaly. For example, data points with a high anomaly score are classified as anomalies depending on data quantiles.

In one or more implementations, a given KPI can have a one-dimensional failure rate (e.g. related to a single feature) or a multi-dimensional failure rate (e.g., related to multiple features). In an example related to a one-dimensional failure rate where the system is only tracking a failure rate of a single feature, the LOF technique is not applied by the anomaly detector 210 to detect anomalies and a ranking algorithm may be utilized instead (e.g., picking the highest failure rates or lowest failure rates).

Alternatively, in an example related to a multi-dimensional failure rate, the anomaly detector 210 can track a failure type (e.g., receiving a failure indicator such as a rejected call 403 code, or a rejected call 404 code) related to the voice call drop failure rate (e.g., the KPI 350). For a given table (e.g., the table 300) that includes a KPI (e.g., the KPI 350) corresponding to feature combinations, the anomaly detector 210 checks a multi-dimensional vector and applies the vector as an input to the LOF technique. For example, if a particular feature combination has a specific failure type with a same failure rate, and a different feature combination has the exact same failure rate but with a completely different failure type, then that different combination will get scored higher when using the local outlier factor algorithm.

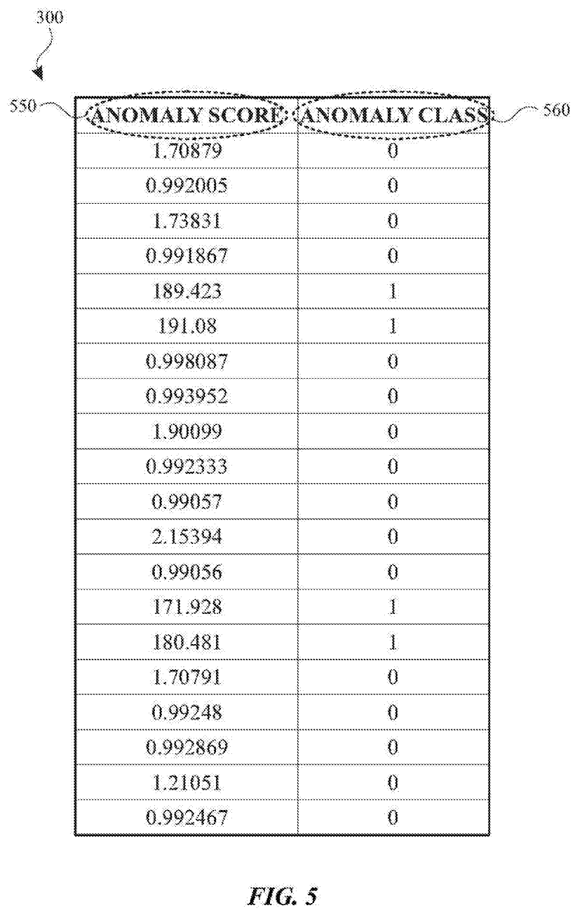

FIG. 5 illustrates an example of LOF related data included in the table 300 in accordance with one or more implementations of the subject technology. After the anomaly detector 210 applies the LOF technique on the input data from the table 300, additional data related to the calculated anomaly scores and/or anomaly classification for the rows of input data from the table 300, may be provided in respective columns that are added to the table 300.

As illustrated, FIG. 5, the table 300 now includes a column 550 includes values of anomaly scores and a column 560 includes values for anomaly classes. As mentioned above, the anomaly detector 210 may utilize a configurable threshold for classifying anomaly scores. For example, a low threshold may be utilized to more aggressively classify anomaly scores as anomalies, while a higher threshold value (e.g., 99%) may more conservatively classify anomaly scores as anomalies.

After the group of feature values from each row of the table 300 are classified according to anomaly classes, the anomaly detector 210 may utilize an information theory approach of determining which feature is more important for the KPI.

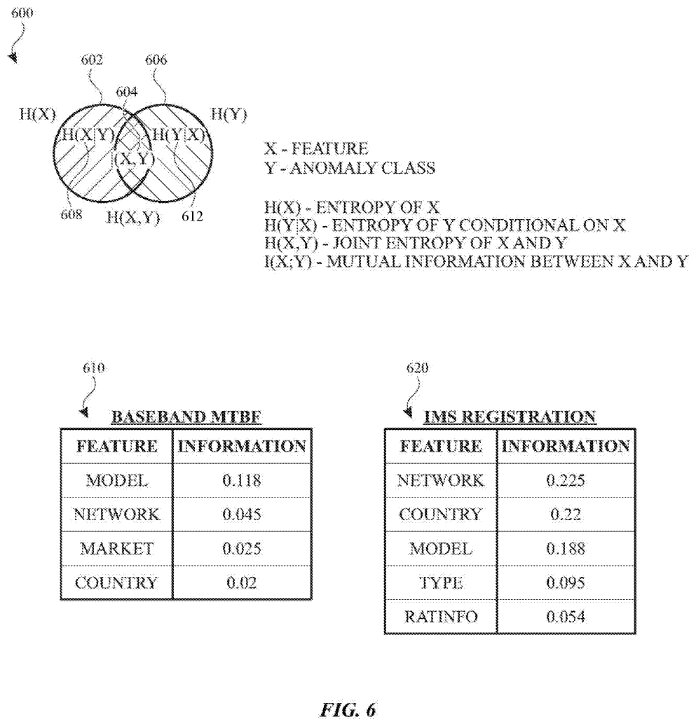

FIG. 6 conceptually illustrates an example use of mutual information for determining important features in accordance with at least one implementation of the subject technology. In an example, mutual information is linked to an entropy of a random variable, a fundamental notion in information theory, that defines the amount of information held in a random variable.

For a given dataset, it is crucial to understand which features have the most contribution to an anomaly in the monitored KPI. Without calculating mutual information, subject matter knowledge or manual iteration over various dimensions/features are used, and potentially requiring more time to determine the impact on monitored KPI.

In an example, the subject technology utilizes information theory techniques to rank the importance of features. In particular, the anomaly detector 210 uses mutual information, which is a measure of the mutual dependence between two random variables (e.g., a particular feature and an anomaly class). The mutual information quantifies the amount of information about one random variable, through the other random variable. In at least an implementation, mutual information techniques can exploit the dependency measure between the features of the dataset to the anomaly class that was generated (e.g., as discussed in FIG. 5).

As illustrated in FIG. 6, an example diagram 600 shows additive and subtractive relationships for various information measures associated with correlated variables X and Y. An area contained by a circle 602 and a circle 606 (e.g., corresponding to a union of the circles 602 and 606) is a joint entropy H(X,Y). The circle 602 on the left is an individual entropy H(X), with an area 608 related to a conditional entropy H(X|Y). The circle 606 on the right is an individual entropy H(Y), with an area 612 related to a conditional entropy H(Y|X). The mutual information I(X;Y) corresponds to the intersection of circles 602 and 606 as indicated by an area 604.

In one or more implementations, the anomaly detector 210 calculates mutual information between each feature and the anomaly class random variable (e.g., the anomaly class from the column 560). The anomaly detector 210 may then divide the value of the mutual information by the entropy of the anomaly class to normalize the calculation. For example, respective features that are part of the mutual information calculation may be related to variables such as a network model, roaming, radio access technology information, pre-conditions, etc. The anomaly detector 210 utilizes the mutual information technique to determine an importance value of each feature with respect to the KPI. Thus, the importance value may be indicative of how impactful each feature is with respect to the KPI.

In one or more implementations, the anomaly detector 210 sorts respective importance values. In particular, features are ranked according to an importance value defined by a ratio denoted as the following:

### I(X,Y)/H(Y)

which corresponds to a feature being divided by an entropy of the anomaly class.

For a particular KPI, the anomaly detector 210 may rank the importance values as determined using mutual information. As further illustrated in FIG. 6, examples of a table 610 that includes respective mutual information of features for a particular KPI related to each crash of a baseband (e.g., a time between baseband crashes/failures using a mean time between errors or MTBE), and a table 620 that includes respective mutual information of features for a second particular KPI related to a percentage of successful IMS (IP Multimedia Subsystem) registrations. In this example, the feature related to “model” has the highest importance value in the table 610, and the feature related to “network” has the highest importance value in the table 620.

Important features, as determined above, may be used for aggregation purposes. In some instances, however, there are correlated features, with high importance values, that may not be considered as a significant contributing feature (e.g., network, country) to an anomaly based on an additional calculation of conditional mutual information as discussed further below.

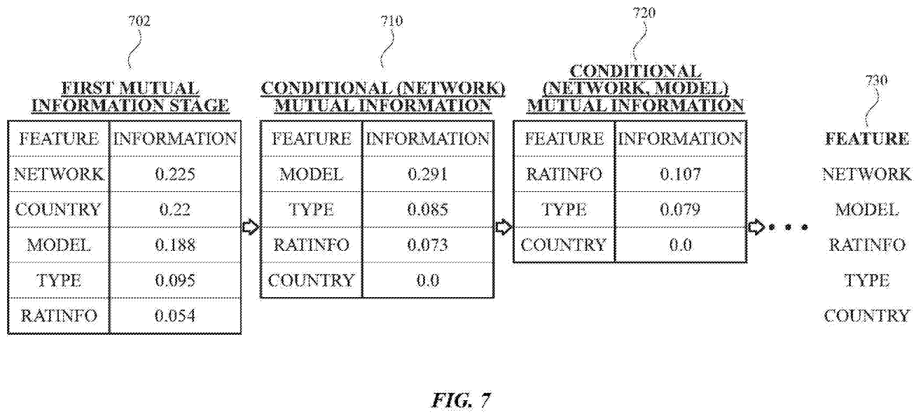

FIG. 7 illustrates an example of tables with conditional mutual information in accordance with some implementations of the subject technology. In FIG. 7, an example is discussed where conditional mutual information is applied to a data set for a particular KPI related to a percentage of successful IMS registrations.

In one or more implementations, the anomaly detector 210 may select a feature with a highest importance value based on mutual information and calculate, in an iteratively manner, conditional mutual information to provide an additional re-ranking of features. The goal of this additional re-ranking using conditional mutual information is to potentially eliminate features that do not include significant additional information with respect to being correlated to a particular KPI being tracked. In this manner, the anomaly detector 210 utilizes conditional mutual information to eliminate redundant features in the data set.

The example of FIG. 7 includes a table 702 related to first mutual information indicating that a feature of “network” has the highest importance value, which the anomaly detector 210 may generate such a table conditioned on a mutual information calculation as previously described above. The anomaly detector 210 then generates, using conditional mutual information applied to the feature of “network”, a table 710. As shown, the table 710 indicates that a feature of “model” has the highest importance value. Next, the anomaly detector 210 generates a table 720 related to conditional mutual information conditioned on the respective features of “network” and “model”. It is appreciated that each of the features in the aforementioned tables may correspond to features that are included in a given input data set stored in a database table (e.g., the table 300).

In the table 702, the feature of “network” has the highest importance value based on mutual information. In the table 710, the feature of “model” has the highest importance value based on conditional mutual information. In the table 720, the feature of “ratInfo” (e.g., radio access technology information) has the highest importance value based on further conditional mutual information between the feature of “network” and the feature of “model”. Using information aggregated from the table 702, the table 710, and the table 720, the anomaly detector 210 sorts the features to generate a ranked set of features 730 based on the respective importance values. In this example, the feature of network has the highest ranking, with features of “model”, “ratInfo”, “type” and “country” following in an order of descending ranking. Even though the feature of “country” was initially indicated as having a relatively high importance value, after iteratively undergoing conditional mutual information processing by the anomaly detector 210, this feature was re-ranked as the least important feature in the set of features 730.

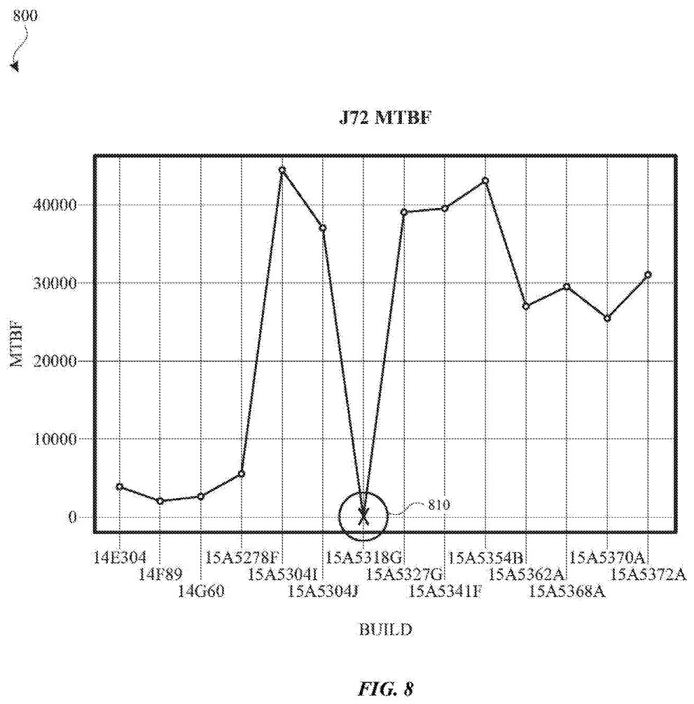

FIG. 8 illustrates an example plot representing a time series in accordance with some implementations of the subject technology. In FIG. 8, an example is discussed where a time series analysis is applied to a data set for a particular a KPI related to a MTBF between baseband failures.

After the features are re-ranked using the iterative approach in determining conditional mutual information, as discussed in FIG. 7, a particular feature with a highest ranking is selected to aggregate the input data. The anomaly detector 210 then performs a time series analysis on the aggregated input data based on a time series value corresponding to different periods of time (e.g., different weeks, or different months, etc.) or based on a parameter partially related to time such as a software version (e.g., build number).

Based on this time series analysis, the anomaly detector 210 can then determine a particular point in the time series (e.g., as depicted in a chart 800) where a significant regression occurred in the data. In the example chart 800, a significant regression is identified, at a point in time 810, for a software version corresponding to build “15A5318g”. After the point in time 810 is identified, the anomaly detector 210 may perform feature profiler techniques based on data related to the point in time 810.

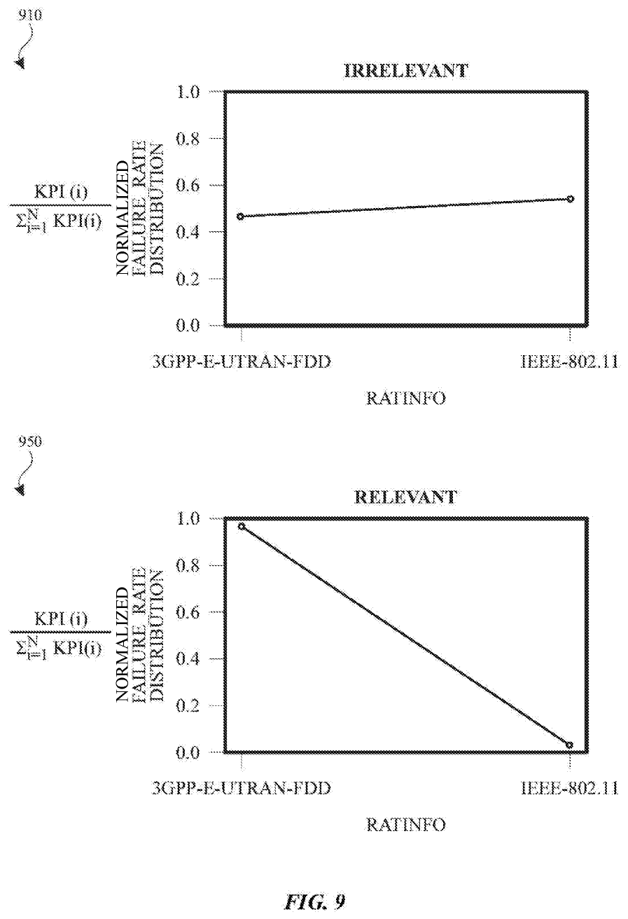

FIG. 9 illustrates example plots of a distribution related to a particular KPI to determine relevancy or irrelevancy of particular features in accordance with one or more implementations of the subject technology.

In an example where the input data includes ten different dimensions (e.g., features), and the input data has been aggregated using the most important dimension (e.g. based on conditional mutual information as discussed above), there could still be several remaining different dimensions that the anomaly detector 210 may determine as relevant or not relevant. Using the point in time (e.g., the point in time 810 where the regression occurred in the data) determined from the time series analysis discussed above, the anomaly detector 210 may apply feature profiler techniques for all the remaining dimensions. For each of the remaining dimensions, a KPI distribution, with respect to different values related to a particular dimension at the point in time, may be plotted to determine relevancy or irrelevancy. In FIG. 9, respective normalized KPI distributions related to a dimension for radio access technology information are shown in a plot 910 and a plot 950. Although two respective plots are shown in FIG. 9, the examples shown may be related to different points in times (e.g., where respective regressions were identified) from different data sets.

In an example, the anomaly detector 210 automatically checks a normalized failure rate distribution related to the KPI for different values of a particular feature. In one or more implementations, the anomaly detector 210 utilizes a standard deviation threshold on a given plot to determine whether the plot is relatively uniform and then determine whether the feature related to the plot is irrelevant or relevant. For example, the plot 910 is indicated as being irrelevant as the standard deviation is relatively uniform. Alternatively, when the distribution of the failure rate, with respect to the values of this feature, shows a high standard deviation, the anomaly detector 210 can determine that this feature is relevant, which is shown in the plot 950. In this manner, the anomaly detector 210 can perform this process for each of the remaining features to eliminate irrelevant dimensions or determine the relevant dimensions from the remaining dimensions.

After determining the relevant features from the data set and the relevant mapping of values of those features (e.g., based on the point in time where a regression was identified), the anomaly detector 210 can send the feedback, in the form of one or more rules, to a device as discussed in the following.

In an implementation, for features with many different values, the subject technology may utilize the following techniques to determine if a particular dimension is relevant or not. For example, a Coefficient of Variation Method (Standard Deviation/Mean) may be implemented, which includes the following operations: 1) calculate a Coefficient of Variation (CV) for the KPI Distribution for a feature; 2) if the CV is less than the uniform distribution threshold, determine that the feature is irrelevant; 3) if the CV is greater than the uniform distribution, then determine that the feature is relevant, remove values until the distribution is uniform, and provide all removed values as a “root cause” for the anomaly. Alternatively, a weighted average check may be implemented which determines if the KPI for a specific value(s) of a feature is above or below a predefined threshold compared to the weighted average KPI.

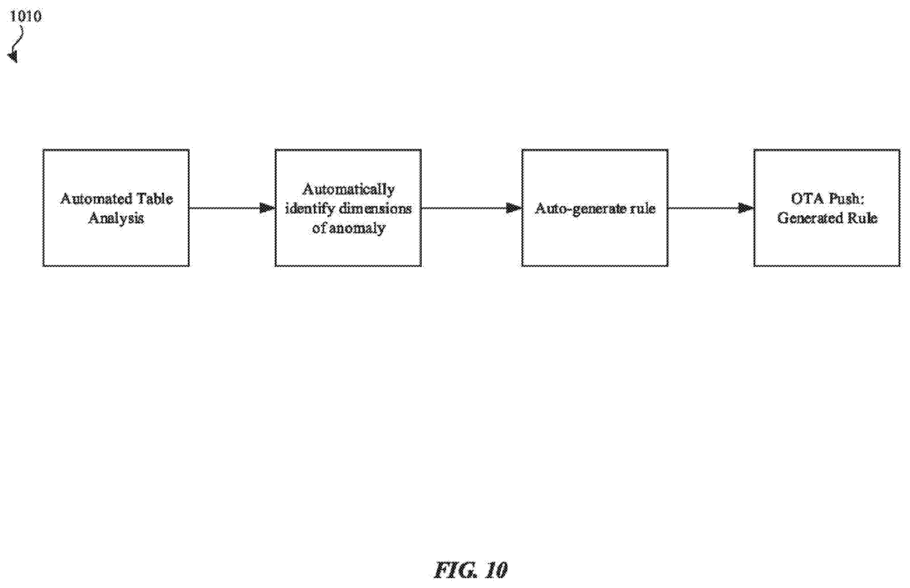

FIG. 10 conceptually illustrates an example workflow for generating rules to provide to a device in order to facilitate addressing an anomaly in accordance with one or more implementations of the subject technology.

In one or more implementations, the anomaly detector 210 may generate expert systems rules for sending to a particular device. Such rules may indicate how the device may avoid or address the failure related to the anomaly. In an implementation, the subject technology provides 1) a rule-based expert system with an inference engine that supports forward chaining, and 2) a tamper-proof secure system to provide OTA (over the air) rules that are expressed in a declarative language for a device in the field.

As illustrated, a workflow 1010 shows example operations to for the anomaly detector 210 to auto-create rules for updating a configuration of a device. The anomaly detector 210 may perform automated table analysis as previously discussed. In one or more implementations, as also illustrated in the workflow 1010, the anomaly detector 210 identifies a particular set of feature values as set of conditions attributed to causing the anomaly. A rule is generated based on the identified feature values and, subsequently, pushed OTA (over the air and/or through a network connection, etc.) to the device. After receiving the rule, the device may take a particular optimization action as a work around to the issue and/or capture more debug information. For example, the rule could provide instructions that when encountering this anomaly with the indicated feature values, the device should perform a particular action such as avoid doing handovers to a network that had setting(s) related to the feature values and/or instructing the device to capture more detailed logs.

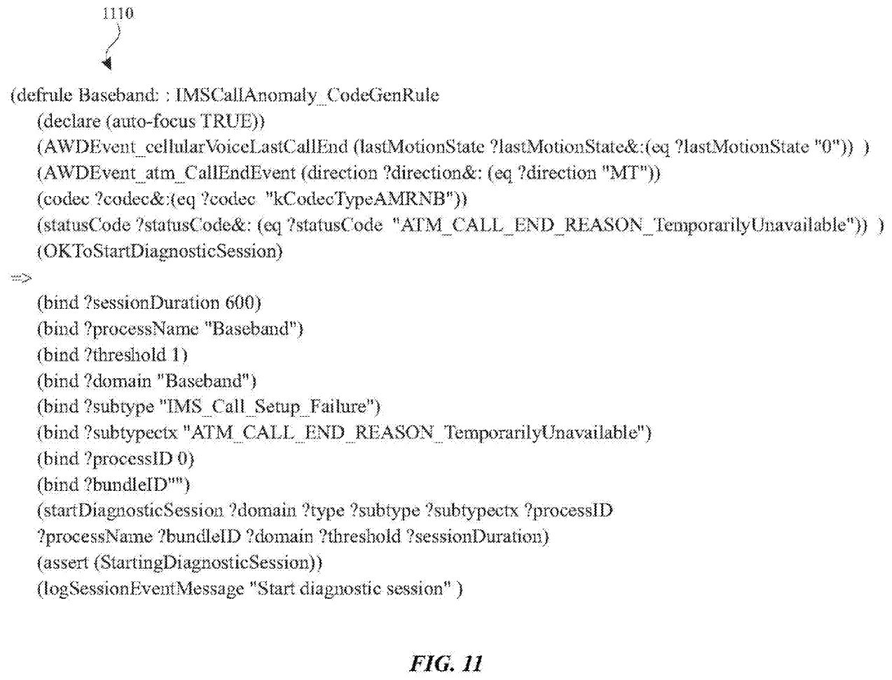

FIG. 11 conceptually illustrates an example rule in accordance with one or more implementations of the subject technology. As illustrated, a rule 1110 includes various actions to perform when encountering a particular anomaly based on a particular feature with a particular value.

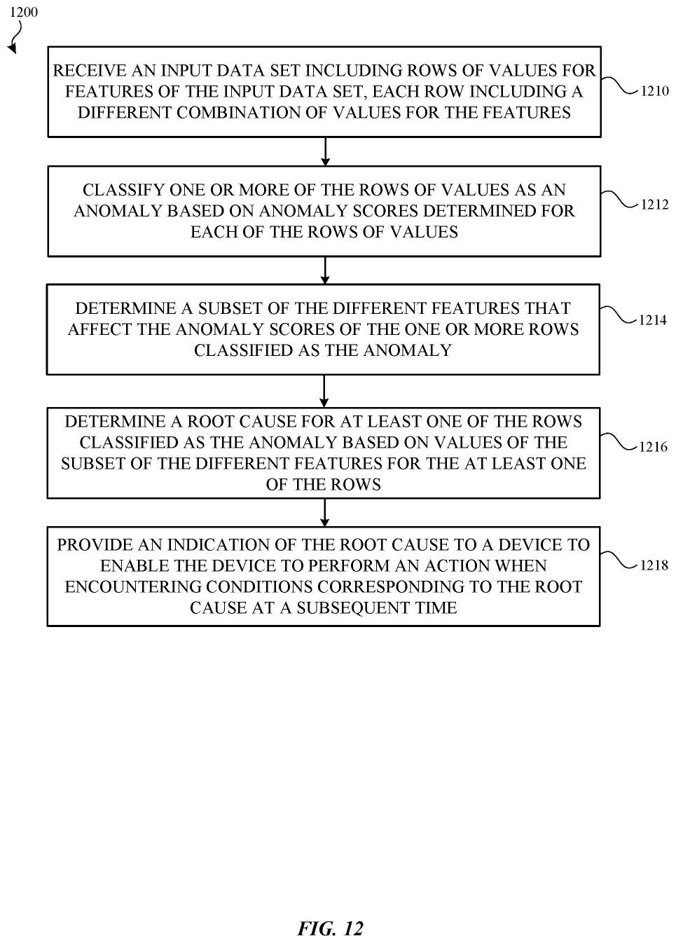

FIG. 12 illustrates a flow diagram of an example process for determining an anomaly in accordance with one or more implementations. For explanatory purposes, the process 1200 is primarily described herein with reference to components of FIG. 2 (particularly with reference to the anomaly detector 210), which may be executed by one or more processors of the server 120 of FIG. 1. However, the process 1200 is not limited to the electronic device 110, and one or more blocks (or operations) of the process 1200 may be performed by one or more other components of other suitable devices. Further for explanatory purposes, the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

The anomaly detector 210 receives an input data set, the input data set including rows of values for different features (1210). In an example, each row may include a different combination of values for the features. The anomaly detector 210 classifies one or more of the rows of values as an anomaly based on anomaly scores determined for each of the rows of values (1212). The anomaly detector 210 determines a subset of the different features that affect the anomaly scores of the one or more rows classified as the anomaly (1214). The anomaly detector 210 determines a root cause for at least one of the rows classified as the anomaly based on values of the subset of the different features for the at least one of the rows (1216). Further, the anomaly detector 210 provides an indication of the root cause to a device to enable the device to perform an action when encountering conditions corresponding to the root cause at a subsequent time (1218).

FIG. 13 illustrates an electronic system 1300 with which one or more implementations of the subject technology may be implemented. The electronic system 1300 can be, and/or can be a part of, the electronic device 110, and/or the server 120 shown in FIG. 1. The electronic system 1300 may include various types of computer readable media and interfaces for various other types of computer readable media. The electronic system 1300 includes a bus 1308, one or more processing unit(s) 1312, a system memory 1304 (and/or buffer), a ROM 1310, a permanent storage device 1302, an input device interface 1314, an output device interface 1306, and one or more network interfaces 1316, or subsets and variations thereof.

The bus 1308 collectively represents all system, peripheral, and chipset buses that communicatively connect the numerous internal devices of the electronic system 1300. In one or more implementations, the bus 1308 communicatively connects the one or more processing unit(s) 1312 with the ROM 1310, the system memory 1304, and the permanent storage device 1302. From these various memory units, the one or more processing unit(s) 1312 retrieves instructions to execute and data to process in order to execute the processes of the subject disclosure. The one or more processing unit(s) 1312 can be a single processor or a multi-core processor in different implementations.

The ROM 1310 stores static data and instructions that are needed by the one or more processing unit(s) 1312 and other modules of the electronic system 1300. The permanent storage device 1302, on the other hand, may be a read-and-write memory device. The permanent storage device 1302 may be a non-volatile memory unit that stores instructions and data even when the electronic system 1300 is off. In one or more implementations, a mass-storage device (such as a magnetic or optical disk and its corresponding disk drive) may be used as the permanent storage device 1302.

In one or more implementations, a removable storage device (such as a floppy disk, flash drive, and its corresponding disk drive) may be used as the permanent storage device 1302. Like the permanent storage device 1302, the system memory 1304 may be a read-and-write memory device. However, unlike the permanent storage device 1302, the system memory 1304 may be a volatile read-and-write memory, such as random access memory. The system memory 1304 may store any of the instructions and data that one or more processing unit(s) 1312 may need at runtime. In one or more implementations, the processes of the subject disclosure are stored in the system memory 1304, the permanent storage device 1302, and/or the ROM 1310. From these various memory units, the one or more processing unit(s) 1312 retrieves instructions to execute and data to process in order to execute the processes of one or more implementations.

The bus 1308 also connects to the input and output device interfaces 1314 and 1306. The input device interface 1314 enables a user to communicate information and select commands to the electronic system 1300. Input devices that may be used with the input device interface 1314 may include, for example, alphanumeric keyboards and pointing devices (also called “cursor control devices”). The output device interface 1306 may enable, for example, the display of images generated by electronic system 1300. Output devices that may be used with the output device interface 1306 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 13, the bus 1308 also couples the electronic system 1300 to one or more networks and/or to one or more network nodes, such as the electronic device 110 shown in FIG. 1, through the one or more network interface(s) 1316. In this manner, the electronic system 1300 can be a part of a network of computers (such as a LAN, a wide area network (“WAN”), or an Intranet, or a network of networks, such as the Internet. Any or all components of the electronic system 1300 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving an input data set including rows of values for different features of the input data set, each row including a different combination of values for the different features;
classifying one or more of the rows of values as an anomaly based on anomaly scores determined for each of the rows of values;
determining a subset of the different features that affect the anomaly scores of the one or more rows classified as the anomaly;
determining a root cause for at least one of the rows classified as the anomaly based on values of the subset of the different features for the at least one of the rows; and
providing an indication of the root cause to a device to enable the device to perform an action when encountering conditions corresponding to the root cause at a subsequent time.

2. The method of claim 1, wherein a particular anomaly score is determined based at least in part on by measuring a local deviation of a data point with respect to one or more other data points that are neighbors of the data point.

3. The method of claim 2, wherein the particular anomaly score is further based on a ratio of average densities of the neighbors of the data point to a density of the data point.

4. The method of claim 1, wherein the subset of the different features is determined based at least in part on conditional mutual information across the different features.

5. The method of claim 1, further comprising:
filtering the input data set based at least in part on statistical filtering to remove outlier rows of values.

6. The method of claim 5, wherein the outlier rows of values are determined based on a threshold value.

7. The method of claim 5, wherein the statistical filtering is based on a probability density function.

8. The method of claim 1, wherein determining the root cause for at least one of the rows classified as the anomaly further comprises:
determining a particular feature from the subset of features with a highest score based on conditional mutual information; and
performing a time series analysis on the particular feature over time to identify a particular time with an increase, greater than a threshold value, in a key performance indicator (KPI), the KPI being related to a particular anomaly.

9. The method of claim 8, wherein the KPI comprises a value indicating a version of software.

10. The method of claim 1, wherein providing the root cause to the device further comprises:
sending, over a network, information related to the root cause to the device.

11. A system comprising;
a processor;
a memory device containing instructions, which when executed by the processor cause the processor to:
receive an input data set including rows of values for different features of the input data set, each row including a different combination of values for the different features;
classify one or more of the rows of values as an anomaly based on anomaly scores determined for each of the rows of values;
determine a subset of the different features that affect the anomaly scores of the one or more rows classified as the anomaly;
determine a root cause for at least one of the rows classified as the anomaly based on values of the subset of the different features for the at least one of the rows; and
provide an indication of the root cause to a device to enable the device to perform an action when encountering conditions corresponding to the root cause at a subsequent time.

12. The system of claim 11, wherein a particular anomaly score is determined based at least in part on by measuring a local deviation of a data point with respect to one or more other data points that are neighbors of the data point.

13. The system of claim 12, wherein the particular anomaly score is further based on a ratio of average densities of the neighbors of the data point to a density of the data point.

14. The system of claim 11, wherein the subset of the different features is determined based at least in part on conditional mutual information across the different features.

15. The system of claim 11, wherein the memory device includes further instructions, which when executed by the processor, further cause the processor to:
filter the input data set based at least in part on statistical filtering to remove outlier values.

16. The system of claim 15, wherein the outlier values are determined based on a threshold value.

17. The system of claim 15, wherein the statistical filtering is based on a probability density function.

18. The system of claim 11, wherein to determine the root cause for at least one of the rows classified as the anomaly further causes the processor to:
determine a particular feature from the subset of features with a highest score based on conditional mutual information; and
perform a time series analysis on the particular feature over time to identify a particular time with an increase, greater than a threshold value, in a key performance indicator (KPI), the KPI being related to a particular anomaly.

19. The system of claim 18, wherein the KPI comprises a value indicating a version of software.

20. A non-transitory computer-readable medium comprising instructions, which when executed by a computing device, cause the computing device to perform operations comprising:
receiving an input data set including rows of values for different features of the input data set, each row including a different combination of values for the different features;
classifying one or more of the rows of values as an anomaly based on anomaly scores determined for each of the rows of values;
determining a subset of the different features that affect the anomaly scores of the one or more rows classified as the anomaly;
determining a root cause for at least one of the rows classified as the anomaly based on values of the subset of the different features for the at least one of the rows; and
providing an indication of the root cause to a device to enable the device to perform an action when encountering conditions corresponding to the root cause at a subsequent time.
